(19) United States
(12) Patent Application Publication
(10) Pub. No.: US 2026/0158977 A1
(43) Pub. Date: Jun. 11, 2026

(54) CHILD SAFETY SEAT WITH IMPACT ENERGY ABSORBING BOLSTERS

(71) Applicant: Britax Child Safety, Inc., Fort Mill, SC (US)

(72) Inventors: Chad Crane, Fort Mill, SC (US); Trent Cook, Fort Mill, SC (US); Michael Calvert, Fort Mill, SC (US)

(21) Appl. No.: 19/413,458

(22) Filed: Dec. 9, 2025

Related U.S. Application Data
(60) Provisional application No. 63/730,538, filed on Dec. 11, 2024.

(51) Int. Cl. B60N 2/28

(52) U.S. Cl. CPC B60N 2/2884

(57) ABSTRACT

Child safety seats including energy absorbing elements in accordance with embodiments of the invention are disclosed. In a variety of embodiments, a child safety seat includes a seat shell, a seat, a backrest, and at least one impact energy absorber located on top of the seat and adjacent to the inner side of the seat shell when the impact energy absorber is in a use position. The impact energy absorbers are each attached to a strap that forms a loop, the strap connects the impact energy absorber to the child safety seat.

### PRIORITY CLAIM AND CROSS-REFERENCE TO RELATED APPLICATION

The present application claims priority to and the benefit of U.S. Provisional Ser. No. 63/730,538 filed Dec. 11, 2024, which is incorporated herein by reference in its entirety and relied upon.

### TECHNICAL FIELD

The present invention relates to a child safety seat, such as a juvenile car seat, with adjustable impact energy absorbing devices. In a particular form the present invention relates to an impact energy absorber. The impact energy absorber is located on the internal side of a child safety seat shell, such that when a child is sitting in the child safety seat, the impact energy absorber is positioned adjacent to the child's hip.

### BACKGROUND

Child safety seats (or simply child seats or car seats) are secured inside a vehicle to protect children in vehicles from the effects of either accidents, sudden deceleration, or other impacts or jarring events. The child safety seats may include various different protective features relating to securing the child safety seats in the vehicle, securing the child to the child safety seat, and protecting the child once the child is secured in the child safety seat. Some of these protective features may be prescribed by regulation in certain jurisdictions, but others may provide optional, additional protection for children. Thus, child safety seats can have a variety of different features, and even different structural arrangements for providing many of those features. Energy absorbing devices are one example of such features.

A typical child safety seat may include a seat portion or seat shell that defines the structure inside which the child is secured. The seat portion is typically operably coupled to a base of some sort, so that the base can support the seat portion and also be securely attached to the vehicle seat. The addition of an energy absorber, such as a side impact protection device, has, in the past, been provided between the seat portion and the base to absorb the energy of impact so that such energy is not experienced by the child.

Accordingly, there is a need for a child safety seat with impact energy absorbing bolsters.

### SUMMARY

Child safety seats including impact energy absorbing elements in accordance with embodiments of the invention are disclosed. In a variety of embodiments, a child safety seat includes a seat body comprising an outer surface and an inner surface and at least one impact energy absorber coupled to the child safety seat. The impact energy absorber may be positioned such that they simultaneously touch the child safety seat backrest, seat, and lower lateral walls. The impact energy absorber may be placed in a use or non-use position. When the impact energy absorber is in a use position, the impact energy absorber is positioned such that it is adjacent to a child's hip when a child is seated in the safety seat.

In light of the disclosure herein, and without limiting the scope of the invention in any way, in a first aspect of the present disclosure, which may be combined with any other aspect listed herein unless specified otherwise, a child safety seat including a seat shell, a seat component, a backrest component, and at least one impact energy absorber.

In a second aspect of the present disclosure, which may be combined with any other aspect listed herein unless specified otherwise, where the seat component is pivotably coupled to the inside the seat shell.

In a third aspect of the present disclosure, which may be combined with any other aspect listed herein unless specified otherwise, where the at least one impact energy absorber selectively couples to the seat shell via a strap coupled to the at least one energy absorber.

In a fourth aspect of the present disclosure, which may be combined with any other aspect listed herein unless specified otherwise, where the strap is configured to selectively couple to the seat shell via sliding through at least one slot on the seat shell.

In a fifth aspect of the present disclosure, which may be combined with any other aspect listed herein unless specified otherwise, where the strap is in a tensioned state when it slides through the at least one slot on the seat shell.

In a sixth aspect of the present disclosure, which may be combined with any other aspect listed herein unless specified otherwise, where the at least one impact energy absorber has an in use configuration and a not in use configuration.

In a seventh aspect of the present disclosure, which may be combined with any other aspect listed herein unless specified otherwise, where in the in use configuration the at least one impact energy absorber is secured to an inner portion of the seat shell at the junction of the backrest and seat component, such that it is located at an occupant's hip area.

In an eighth aspect of the present disclosure, which may be combined with any other aspect listed herein unless specified otherwise, where in the not in use configuration the at least one impact energy absorber is located on an outward facing portion of the seat shell.

In a ninth aspect of the present disclosure, which may be combined with any other aspect listed herein unless specified otherwise, where the at least one impact energy absorber is comprised of expanded polypropylene foam (“EPP”).

In a tenth aspect of the present disclosure, which may be combined with any other aspect listed herein unless specified otherwise, where the at least one impact energy absorber is enclosed in a laminated foam cover.

In an eleventh aspect of the present disclosure, which may be combined with any other aspect listed herein unless specified otherwise, where the at least one impact energy absorber has a rectangular shape.

In a twelfth aspect of the present disclosure, which may be combined with any other aspect listed herein unless specified otherwise, where the rectangular shape is 102 mm in length, 32 mm in width, and 102 mm in height.

In a thirteenth aspect of the present disclosure, which may be combined with any other aspect listed herein unless specified otherwise, an impact energy absorber assembly for a child safety seat, the impact energy absorber assembly including at least one impact energy absorber, where the at least one impact energy absorber couples to a child seat.

In a fourteenth aspect of the present disclosure, which may be combined with any other aspect listed herein unless specified otherwise, further comprising a strap, where the strap selectively couples the at least one impact energy absorber to the child safety seat such that the at least one impact energy absorber is located between an occupant's hip area and the child safety seat.

In a fifteenth aspect of the present disclosure, which may be combined with any other aspect listed herein unless specified otherwise, where the at least one impact energy absorber is rectangular in shape and comprised of an energy absorbing material.

In a sixteenth aspect of the present disclosure, which may be combined with any other aspect listed herein unless specified otherwise, an impact energy absorber system, the system including a child safety seat, at least one impact energy absorber.

In a seventeenth aspect of the present disclosure, which may be combined with any other aspect listed herein unless specified otherwise, further comprising a strap, where the strap is coupled to the at least one impact energy absorber, and where the at least one impact energy absorber selectively couples to the child safety seat via the strap.

In an eighteenth aspect of the present disclosure, which may be combined with any other aspect listed herein unless specified otherwise, where the strap is configured to selectively couple to the child safety seat via sliding through at least one slot on the child safety seat.

In a nineteenth aspect of the present disclosure, which may be combined with any other aspect listed herein unless specified otherwise, where the at least one impact energy absorber has an in use configuration and a not in use configuration.

In a twentieth aspect of the present disclosure, which may be combined with any other aspect listed herein unless specified otherwise, where in the in use configuration the at least one impact energy absorber is secured to the child safety seat such that the at least one impact energy absorber is located between an occupant's hip area and the child safety seat.

In a twenty-first aspect of the present disclosure, any of the structure, functionality, and alternatives disclosed in connection with any one or more of FIGS. 1 to 15 may be combined with any other structure, functionality, and alternatives disclosed in connection with any other one or more of FIGS. 1 to 15.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE DRAWINGS

FIGS. 1A to 1B illustrate examples of perspective views of a child safety seat fitted with impact energy absorber in a use position.

FIG. 2 illustrates an example of a perspective view of the backside of a child safety seat when the impact energy absorbers are in a use position.

FIGS. 3A to 3B illustrate examples of perspective views of the front side of a child safety seat to detailing the location of the aperture in the seat shell.

FIG. 4 illustrates an example of a perspective view of the child safety seat's internal seat shell comprising slots for the strap to pass through.

FIG. 5 illustrates an example of a perspective view of a child safety seat fitted with the impact energy absorbers in a non-use position.

FIG. 6 illustrates an example of a perspective view of an impact energy absorber in an alternative non-use position.

FIG. 7 illustrates an example of a perspective view of an impact energy absorber located adjacent to a child's hip.

FIG. 8 illustrates an example of a perspective view of the child safety seat cushion's plurality of slots.

FIG. 9 illustrates an example of a perspective view of the impact energy absorbing device.

FIGS. 10A to 10B illustrate examples of perspective views of an impact energy absorption device and its dimensions.

FIG. 11 illustrates an example perspective view of a child safety seat with a seat bottom impact energy absorbing device.

FIG. 12 illustrates an example perspective view of a seat bottom impact energy absorbing device.

FIG. 13 illustrates an example perspective view of the attachment points for webbing tabs.

FIG. 14 illustrates an example of a perspective view of an impact energy absorber that is attached to the seat cushion in a non-use position.

FIG. 15 illustrates an alternate example of a perspective view of an impact energy absorber that is attached to the seat cushion in a non-use position.

### DETAILED DESCRIPTION

Methods, systems, and apparatus are disclosed herein for a child safety seat including impact energy absorbing elements. Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specific the presence of stated features, integers, steps, operations, elements, and/or components, but do not preclude the presence or additional of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent”). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

A child seat is configured for installation based on the height and weight of a child and according to various guidelines and standards, such as those of the United States National Highway Transportation Safety Administration. To ensure maximum protection for an occupant of the child seat, the child seat may be secured to a fixed location in a vehicle, such as using a seat belt of the car seat or LATCH (Lower Anchors and Tethers for Children) attachments. When seat belts are used to secure the child seats, the seat belts are typically positioned around the child seat and then engaged with a buckle attached to the car seat.

However, securing the seat to the vehicle provides only part of the required protection. Ensuring the child seat is the correct shape and size (“fit”) for the child then completes the protection required to cushion and support the child both for everyday comfort and for an impact event.

With this in mind, described herein is an impact energy absorber for a child safety seat that provides for better conforming the seat and internal cushioning around the child. The impact energy absorber is also a SIP, that is positioned adjacent to the inner seat shell and the backrest and/or is the fixed liner of a child safety seat. Various other advantages and benefits may be realized with the impact energy absorber described herein, and the benefits and advantages described herein should not be considered limiting.

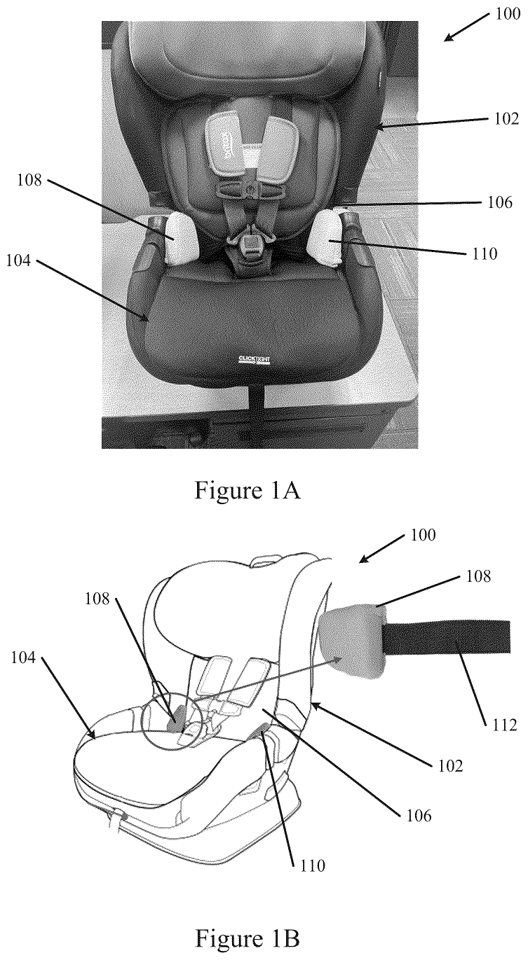

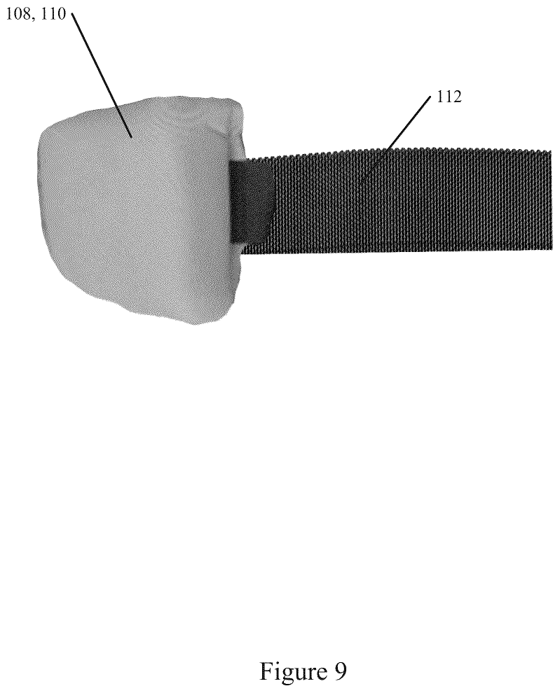

FIGS. 1A to 1B illustrate examples of perspective views of a child safety seat fitted with impact energy absorbers in a use position. The child safety seat 100 includes a seat shell 102, a seat 104, a backrest 106. The child safety seat includes one or more impact energy absorbers 108, 110. In a use position, the impact energy absorbers 108, 110 are located on top of the seat 104 and adjacent to the inner side of the seat shell 102. Additionally, in the use position, a portion of the impact energy absorbers 108, 110 may be touching the backrest 106. Referring to FIG. 1B, the impact energy absorbers 108, 110 are each attached to a strap 112. The strap 112 may be made of any suitable flexible material, such as webbing or the same material as a child safety seat belt. Additionally, as shown in FIG. 9, the strap may be a loop, such that two ends of the strap are attached to the impact energy absorbers 108, 110.

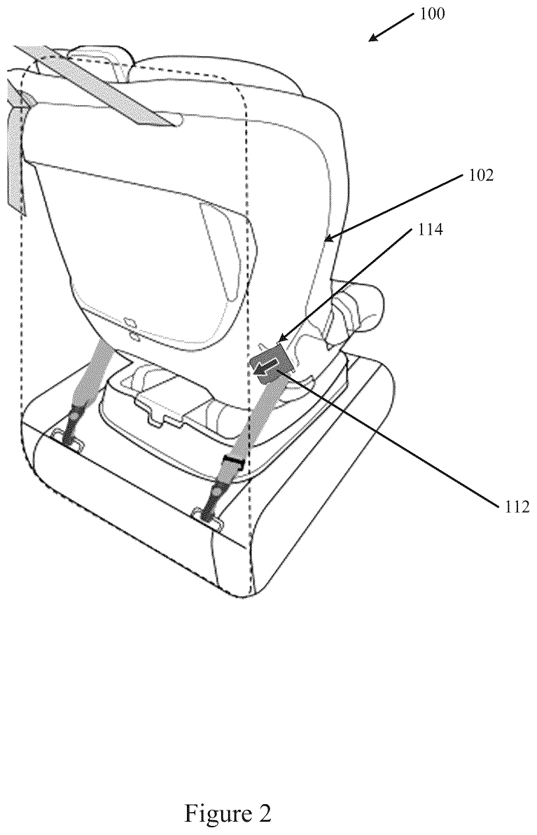

FIG. 2 illustrates an example of a perspective view of the backside of a child safety seat when the impact energy absorbers are in a use position. As discussed above in reference to FIG. 1, the impact energy absorbers 108, 110 are attached to the strap 112. Now, as shown in FIG. 2, impact energy absorbers 108, 110 are not visible from the backside of the child safety seat 100 in the use position. However, a portion of the strap 112 is visible from the backside of the child safety seat 100 when the impact energy absorbers 108, 110 are in the use position. The strap 112 is visible because it is threaded through an aperture 114 in the seat shell 102 and attached to the backside of the seat shell 102. The strap 112 may be permanently affixed to the backside of the seat shell 102. For example, the strap 112 may be screwed into the backside of the seat shell 102 such that the strap 112 cannot be removed without the use of tools. In alternative embodiments, the strap 112 may be removably affixed to the backside of the seat shell 102, such as by a snap, tie, or clasp connection, or any other suitable connection.

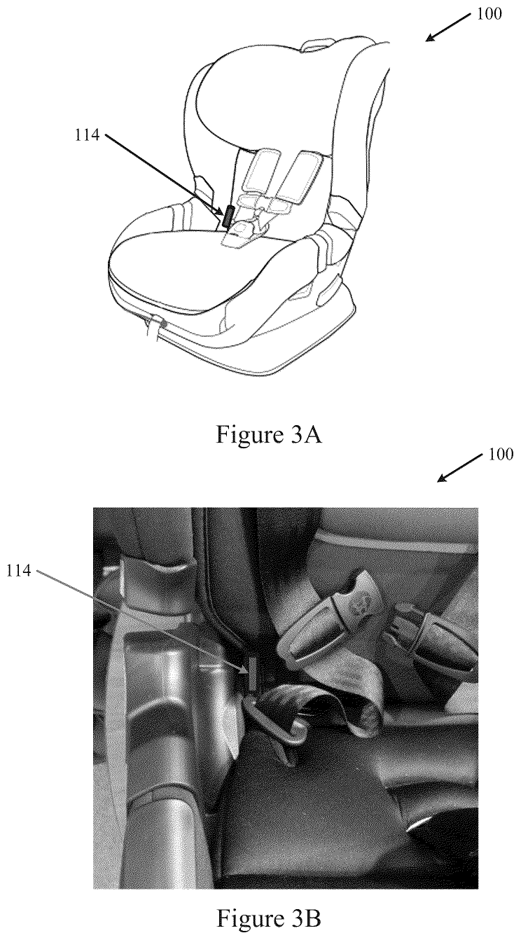

FIGS. 3A to 3B illustrate examples of perspective views of the front side of a child safety seat to detailing the location of the aperture in the seat shell. Although not shown in FIG. 3A or 3B, but as discussed above with reference to FIG. 2, the strap 112 is thread through an aperture 114 located in the seat 104. There may be an aperture 114 on each side of the seat shell 102 to accommodate the strap 112 attached to one or more impact energy absorbers 108, 110. Now, continuing with FIGS. 3A and 3B, the aperture 114 may be any suitable shape and size to accommodate the size of the strap 112 (the strap 112 is not shown in FIG. 3A or 3B). In a preferred embodiment, the aperture 114 is only slightly wider than the width of the strap 112 to prevent the strap 112 from moving around in the aperture 114. Because the strap 112 is attached to the impact energy absorbers 108, 110 (impact energy absorbers 108, 110 are not shown in FIG. 3A or 3B), the strap 112 should remain steady in the use position to ensure the impact energy absorbers 108, 110 will remain steady and in place as well. Thereby, enhancing the safety effects of the impact energy absorbers 108, 110.

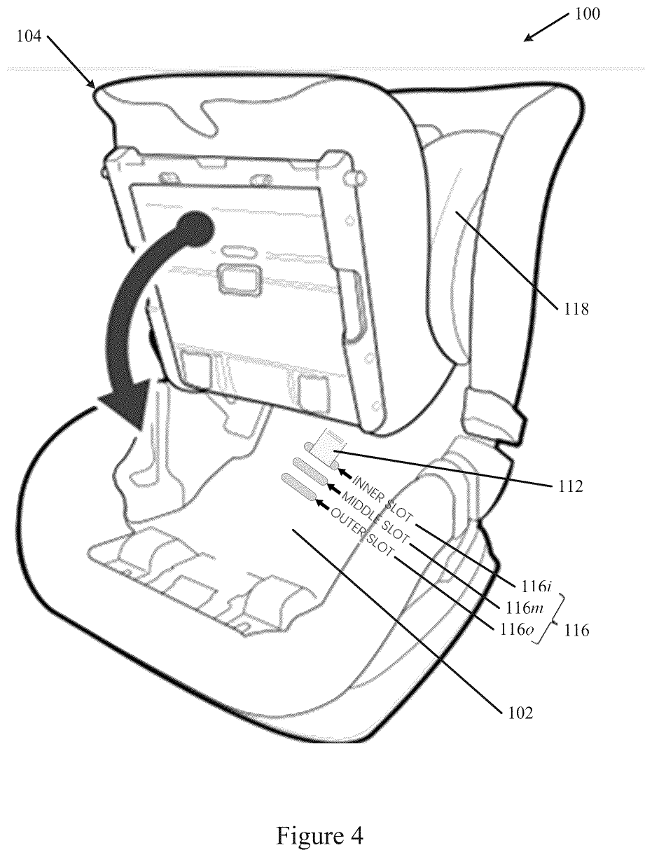

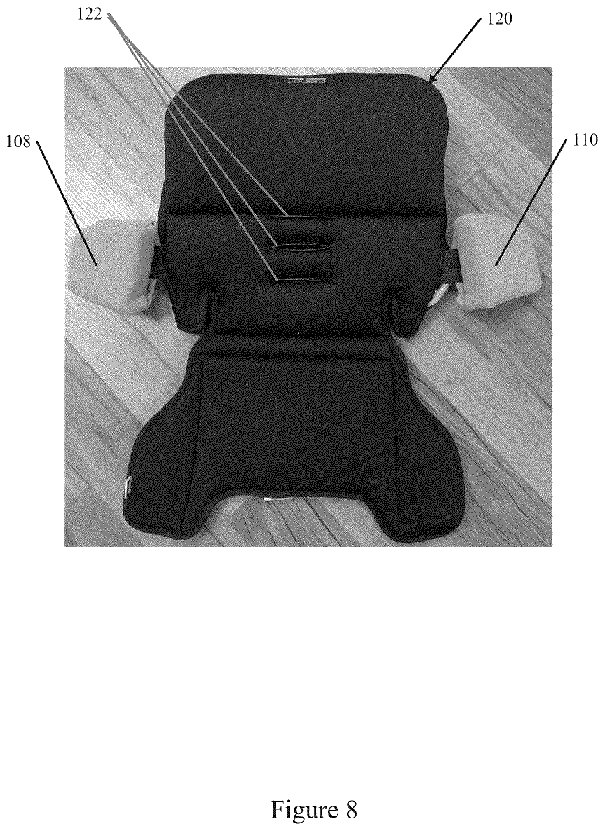

FIG. 4 illustrates an example of a perspective view of the child safety seat's internal seat shell comprising slots for the strap to pass through. The internal side of the seat shell 102 may include a plurality of slots 116 that the strap 112 may be threaded through. The plurality of slots 116 may include an inner slot 116i, a middle slot 116m, and an outer slot 116o. The slots 116i, 116m, 116o may be oriented parallel to each other, and may be spaced equidistant from each other. Although not shown in FIG. 3, the middle slot 116m and outer slot 116o may be used as an attachment component for the child safety seat's 100 belt or harness, while leaving the inner slot 116i available for use by the strap 112 attached to the impact energy absorbing device. Now, continuing with FIG. 3, the inner slot 116i may function as an attachment element for the strap 112. Specifically, the strap 112 may be thread through the inner slot 116i to hold the strap 112 in place on the child safety seat 100. A user may lift the seat 104 upwards towards the headrest 118 to expose the plurality of slots 116, and thereby expose the strap 112. As shown in FIG. 8, the seat cushion 120 includes a plurality of slots 122 that correspond to the plurality of slots 116 (shown in FIG. 4).

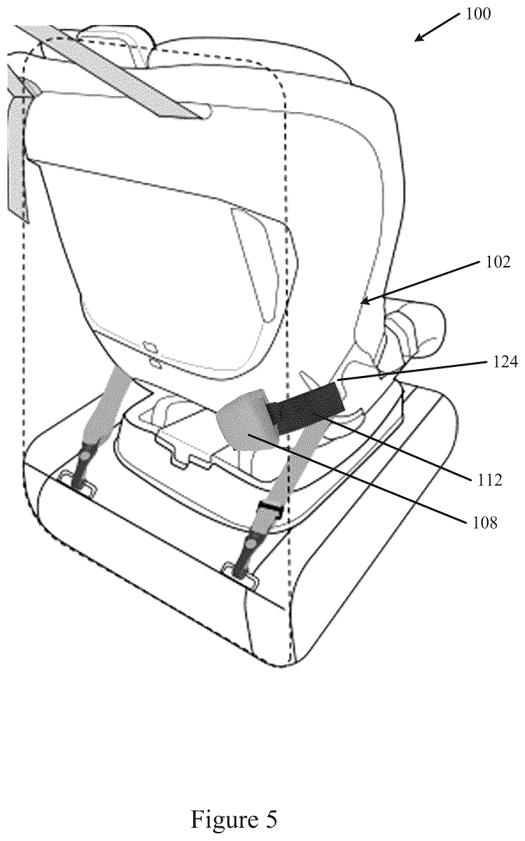

FIG. 5 illustrates an example of a perspective view of a child safety seat fitted with the impact energy absorbers in a non-use position. In the non-use position, the impact energy absorbers 108, 110 (only one impact energy absorber 108 is shown in FIG. 5), may be stored at the backside of the back of the seat shell 102. For example, a user may dislodge the impact energy absorbers 108, 110 from their position against the seat 104, backrest 106, and internal walls of the seat shell 102 (as shown in detail in FIGS. 1A to 1B). Once the impact energy absorbers 108, 110 are dislodged, the user may pull the impact energy absorbers 108, 110 outwards, i.e., away from the center of the child safety seat 100. Then, the user may pull the impact energy absorbers 108, 110 around the side of the child safety seat 100 and towards the backside of the seat shell 102. During this motion, the strap 112 passes through an opening 124 in the side of the seat shell 102. When the impact energy absorbers reach the backside of the seat shell 102, the impact energy absorbers 108, 110 may be stored against the backside of the seat shell 102. For example, the impact energy absorbers may be clasped, hooked, or snapped to the backside of the seat shell 102. Additionally, the impact energy absorbers 108, 110 may be attached to a connection element (not shown) on the portion of the strap 112 that is permanently affixed to the backside of the seat shell 102, such that the impact energy absorbers 108, 110 are not directly coupled to the backside of the seat shell 102. That is, in the non-use position, the impact energy absorbers 108, 110 may be indirectly coupled to the backside of the seat shell 102 and the strap 112 is the mediating connecting element.

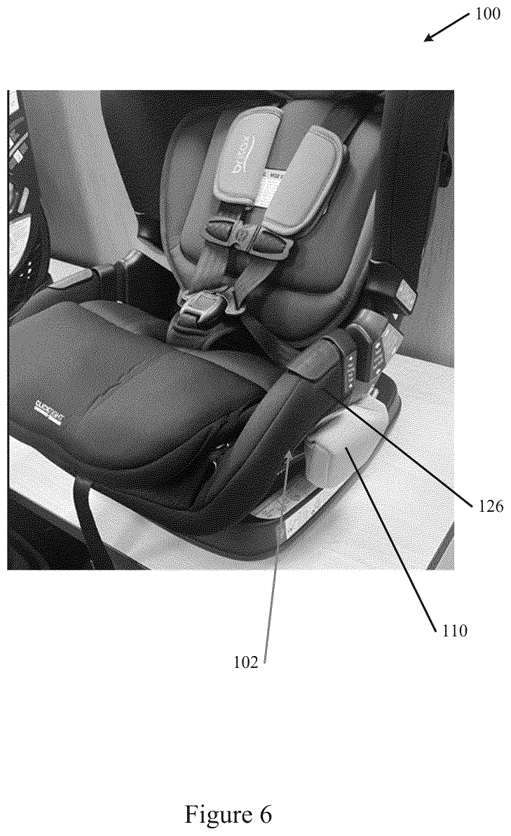

FIG. 6 illustrates a perspective view of an impact energy absorber in an alternative non-use position. The impact energy absorbers 108, 110 may be dislodged from the use position in the same manner as discussed above with reference to FIG. 5. However, as shown in FIG. 6, the impact energy absorber 110 is placed over the side lower lateral side 126 of the seat shell 102.

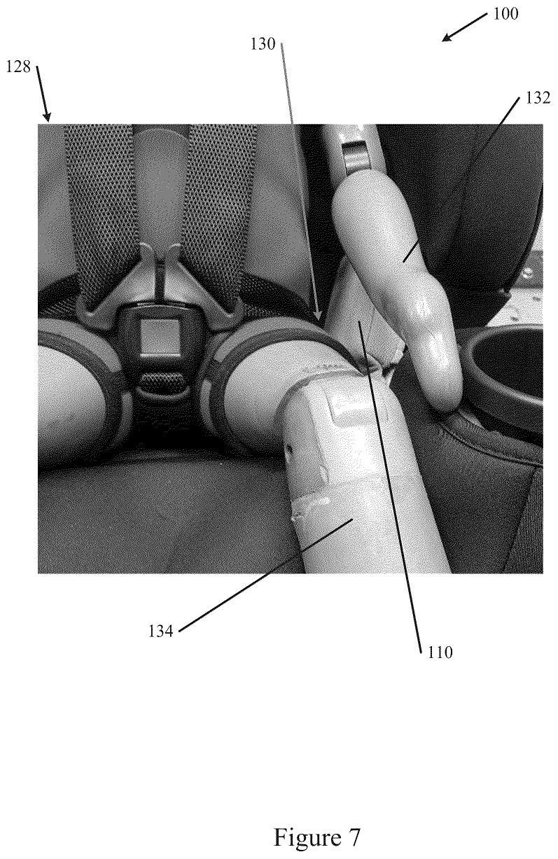

FIG. 7 illustrates a perspective view of an impact energy absorber located adjacent to a child's hip. The impact energy absorbers 108, 110 (only one impact energy absorber 110 is shown in FIG. 7) may be shaped and located to provide support and impact protection to a child seated in the child safety seat 100. Further, when a child 128 is sitting in the child safety seat 100, the impact energy absorbers 108, 110 may be located adjacent to the child's hip 130. Thus, when the child 128 is sitting in the child safety seat 100, the impact energy absorbers 108, 110 aid in positioning the child's arm or arms 132 above the child's legs 134. For example, when a child is sitting in the child safety seat 100 the impact energy absorbers 108, 110 are located beside the child's hip 130, and the child's arms 132 may rest on top of the impact energy absorbers 108, 110. The impact energy absorbers 108, 110 may provide enhanced safety benefits when located at the child's hip 130, as opposed to, for example, being located at a higher position such as next to the child's ribs. Namely, impact energy absorbers 108 are positioned at hip-height (thus ensuring any side impact is directed into a child's hip) as opposed to rib-height (thus avoiding any side impact being directed into a child's torso, arms, or shoulders).

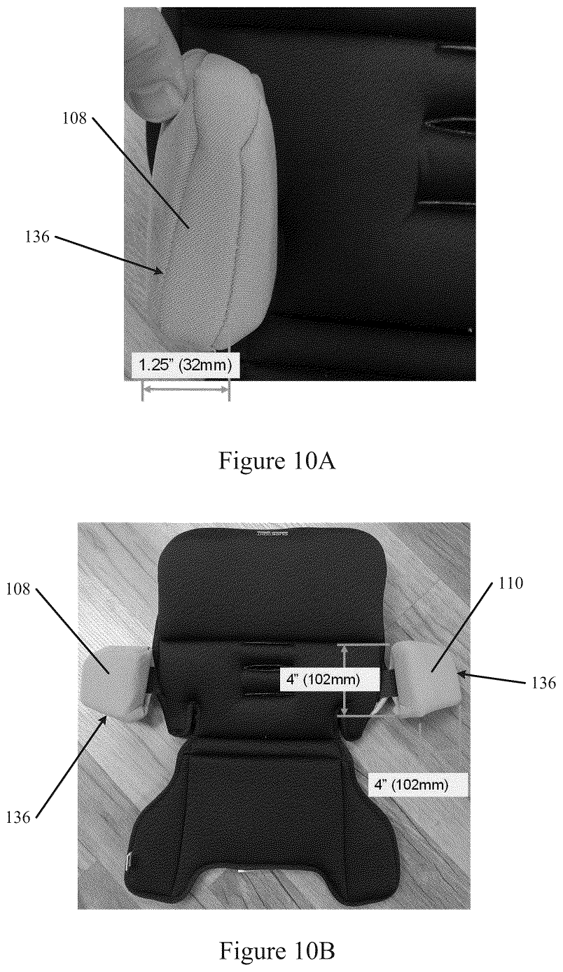

Further, the impact energy absorption devices 108, 110 of any one of FIGS. 1 to 7 may be bolsters, e.g., pillows or cushions. Specifically, the impact energy absorption devices 108, 110 may be made from a foam (not directly shown in the figures), such as expanded polypropylene foam (“EPP”), or a similar energy absorbing material, and may further be enclosed in a laminated foam cover. The laminated foam cover may help soften the energy absorbing material that makes up the impact energy absorbers 108, 110. Additionally, the impact energy absorbers 108, 110 may be modular in nature, allowing a user to select from combinations of the impact energy absorption devices 108, 110 to provide a gradual and measured increase in the size and shape of the area the child sits in as the child grows and matures. Moreover, the impact energy absorption devices 108, 110 may be provided in a variety of sizes to accommodate different child sizes. For example, as shown in FIGS. 10A to 10B, the impact energy absorption devices 108, 110 may be approximately 102 mm in length, 32 mm in width, and 102 mm in height, and the laminated foam cover may be approximately 5 mm thick. It should be appreciated that other dimensions are likewise contemplated herein.

With reference to all of FIGS. 1 to 7, when the impact energy absorbers 108, 110 are in the use or non-use position, the impact energy absorbers 108, 110 may be positioned in such a way that avoids interfering with the required safety labels in accordance with all requisite regulations.

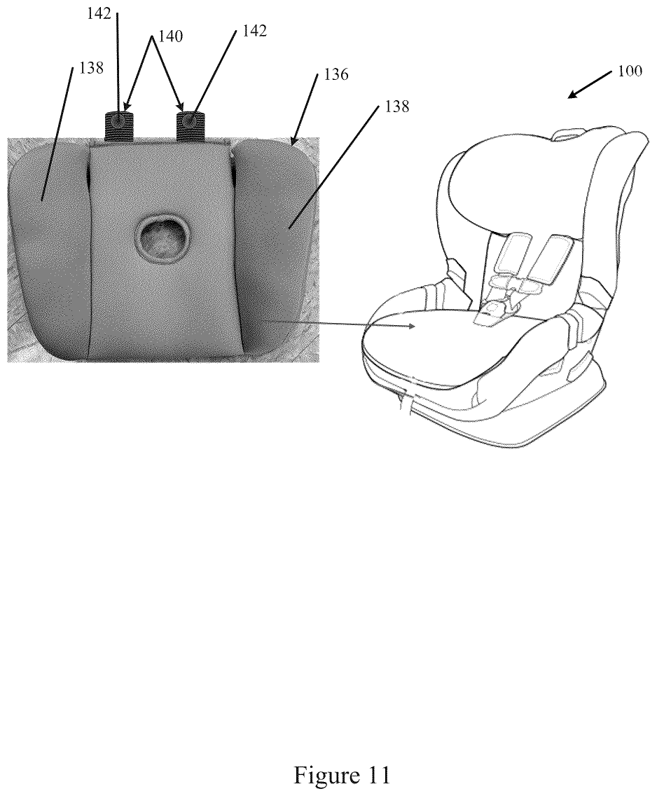

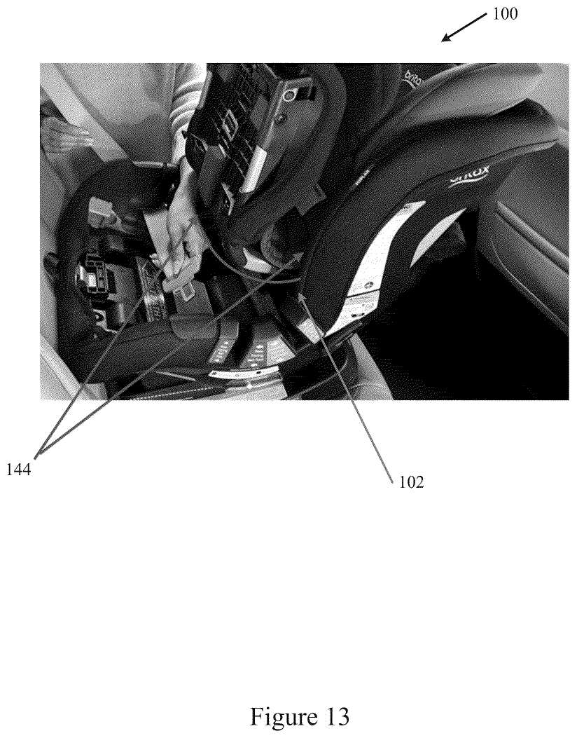

FIG. 11 illustrates an example perspective view of a child safety seat with a seat bottom impact energy absorbing device with attachment webbing. The child safety seat 100 includes a seat bottom impact energy absorber 136. The seat bottom impact energy absorber 136 is positioned on top of the seat cushion (not shown), and includes panels 138 with the required amount of EPP. The impact energy absorber 136 further includes at least one webbing tab 140 with an attachment element 142. The attachment element 142 may be a screw. The attachment element couples the impact energy absorber 136 to the child safety seat 100. Specifically, one or more webbing tabs 140 are threaded through buttonhole slots (not shown) in the seat cover and are attached, or screwed, into attachment points 144 located on the internal side of the seat shell 102, as shown in FIG. 13.

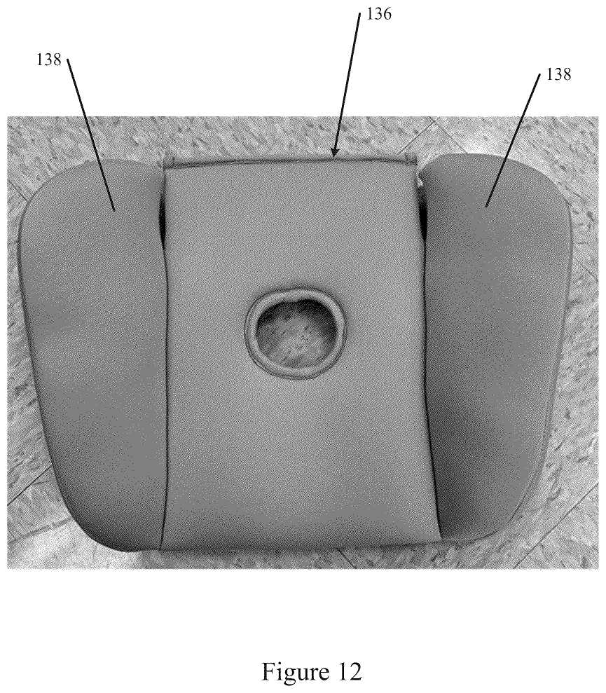

FIG. 12 illustrates an example perspective view of an alternative insertable seat bottom impact energy absorber. The seat bottom impact energy absorber 136 may be a fully insertable seat insert that may further include at least two panels 138 on each side of the insert. The panels 138 are filled with the required standard amount of EPP. The impact energy absorber 136 may be permanently inserted into the seat cushion of the child safety seat.

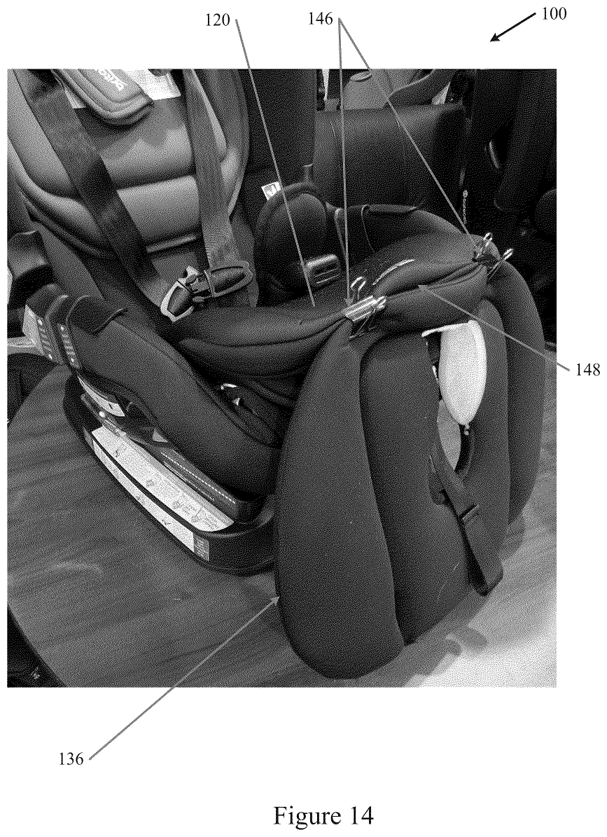

FIG. 14 illustrates an example of a perspective view of an impact energy absorber that is attached to the seat cushion in a non-use position. The seat bottom impact energy absorber 136 includes a fastener component 146 at the front edge 148 of the seat cushion 120, as opposed to attaching to the hard goods of the seat shell 102 as described with reference to FIG. 13. For example, the seat bottom impact energy absorber 136 can be removably mounted to the seat cushion 120 by way of the fastener component 146. The fastener component 146 may retain the seat bottom impact energy absorber 136 in fixed locations to prevent it from being inadvertently displaced or incorrectly positioned. The fastener component 146 may comprise a plurality of fasteners. The fasteners can be selected from (but not limited to) pop-studs, buttons, zips, Velcro, magnets, and ties, to allow the seat bottom impact energy absorber to be removed. Alternatively, the seat bottom impact energy absorber can be permanently fastened to the seat cushion. For example, the seat bottom impact energy absorber 136 can be sewn or glued to the seat cushion 120.

Additionally, only the front edge of the seat bottom impact energy absorber may be removably or permanently fastened to the front edge of the seat cushion 120. Therefore, the impact energy absorber 136 is capable of flipping down to remove the seat bottom impact energy absorber 136 from the top of the seat cushion 120. When the impact energy absorber 136 is flipped down, it is in the non-use position (the non-use position is shown in FIG. 14). In this example, the non-use position refers to the position when the impact energy absorber 136 is not being used as an energy absorbing safety device. However, even when the impact energy absorber 136 is in this flipped down non-use position, the impact energy absorber 136 may be used as a foot or leg rest for a child sitting in the child safety seat 100.

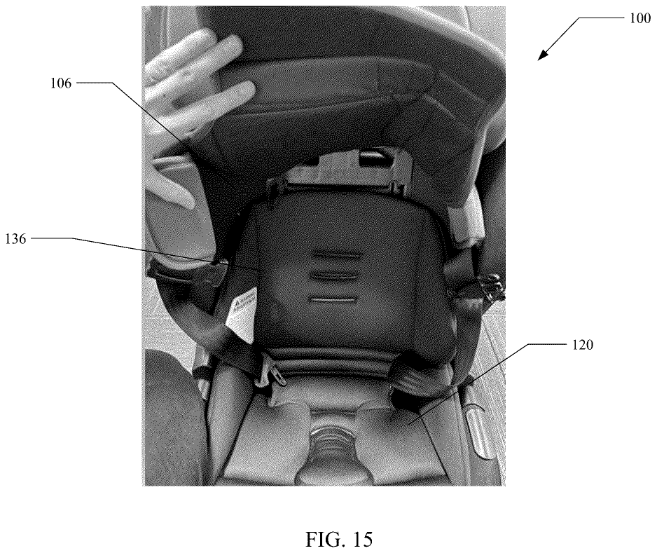

In an alternate embodiment, shown in FIG. 15, the impact energy absorber 136 is coupled to the rear edge of the seat cushion 120. As such, when in non-use configuration, as seen in FIG. 15, the impact absorber 136 is flipped up and positioned against the backrest of the seat 106.

It will be appreciated that a complete impact energy absorber comprises a plurality of energy absorbing elements, and that during impact when the outer surface of the device collapses toward the elements, the elements will work as an array or series of impact absorbing elements, to collectively deform under the force of the impact, resulting in the energy absorbing device collapsing over a longer period of time. The amount of impact energy then transferred to the occupant of the restraint is reduced compared to a ‘standard’ air cushion with generally flat front and back surfaces.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention.

1. A child safety seat comprising:
a seat shell,
a seat component,
a backrest component, and
at least one impact energy absorber.

2. The child safety seat of claim 1, wherein the seat component is pivotably coupled to the inside the seat shell.

3. The child safety seat of claim 1, wherein the at least one impact energy absorber selectively couples to the seat shell via a strap coupled to the at least one energy absorber.

4. The child safety seat of claim 3, wherein the strap is configured to selectively couple to the seat shell via sliding through at least one slot on the seat shell.

5. The child safety seat of claim 4, wherein the strap is in a tensioned state when it slides through the at least one slot on the seat shell.

6. The child safety seat of claim 1, wherein the at least one impact energy absorber has an in use configuration and a not in use configuration.

7. The child safety seat of claim 6, wherein in the in use configuration the at least one impact energy absorber is secured to an inner portion of the seat shell at the junction of the backrest and seat component, such that it is located at an occupant's hip area.

8. The child safety seat of claim 6, wherein in the not in use configuration the at least one impact energy absorber is located on an outward facing portion of the seat shell.

9. The child safety seat of claim 1, wherein the at least one impact energy absorber is comprised of expanded polypropylene foam (“EPP”).

10. The child safety seat of claim 9, wherein the at least one impact energy absorber is enclosed in a laminated foam cover.

11. The child safety seat of claim 1, wherein the at least one impact energy absorber has a rectangular shape.

12. The child safety seat of claim 11, wherein the rectangular shape is 102 mm in length, 32mm in width, and 102 mm in height.

13. An impact energy absorber assembly for a child safety seat, the impact energy absorber assembly comprising:
at least one impact energy absorber,
wherein the at least one impact energy absorber couples to a child seat.

14. The impact energy absorber assembly of claim 13, further comprising a strap, wherein the strap selectively couples the at least one impact energy absorber to the child safety seat such that the at least one impact energy absorber is located between an occupant's hip area and the child safety seat.

15. The impact energy absorber assembly of claim 13, wherein the at least one impact energy absorber is rectangular in shape and comprised of an energy absorbing material.

16. An impact energy absorber system, the system comprising:
a child safety seat, and
at least one impact energy absorber.

17. The system of claim 16, further comprising a strap, wherein the strap is coupled to the at least one impact energy absorber, and wherein the at least one impact energy absorber selectively couples to the child safety seat via the strap.

18. The system of claim 17, wherein the strap is configured to selectively couple to the child safety seat via sliding through at least one slot on the child safety seat.

19. The system of claim 16, wherein the at least one impact energy absorber has an in use configuration and a not in use configuration.

20. The system of claim 19, wherein in the in use configuration the at least one impact energy absorber is secured to the child safety seat such that the at least one impact energy absorber is located between an occupant's hip area and the child safety seat.
